(19) United States
(12) Patent Application Publication
(10) Pub. No.: US 2011/0148578 A1
(43) Pub. Date: Jun. 23, 2011

(54) AUTOMOTIVE DIRECTION FINDING SYSTEM BASED ON RECEIVED POWER LEVELS

(75) Inventors: Daniel N. Aloi, Rochester Hills, MI (US); Mohammad S. Sharawi, Dhahran (SA)

(73) Assignee: Oakland University, Rochester, MI (US)

(21) Appl. No.: 12/959,772

(22) Filed: Dec. 3, 2010

Related U.S. Application Data
(60) Provisional application No. 61/283,822, filed on Dec. 9, 2009.

(51) Int. Cl. G08B 5/22

(52) U.S. Cl. 340/8.1

(57) ABSTRACT

A system is provided for locating a vehicle. The system comprises a transmission device such as a key fob for transmission and receiving of a signal. Typically the key fob has a plurality of indicators such as LED indicators arranged in a circle. The key fob is adapted to transmit a radio frequency or microwave frequency transmission signal. An antenna array is positioned on or in a vehicle. The array comprises a plurality of antennas, generally arranged in a circular pattern. The array is adapted to receive the transmission signal from the transmission device which is converted to be analyzed by a microcontroller unit (MCU). The MCU is adapted to: (i) receive digital data converted from the transmission signal, (ii) calculate an angle of arrival (AOA) or direction of arrival (DOA) based on known components and an algorithm, and (iii) transmit a selection signal back to the key fob. A signal processing unit is coupled to the plurality of antennas and the MCU. The signal processing unit is adapted to receive the signal transmission from each antenna, convert the signal to digital data, and transmit the digital data to the MCU.

### CROSS-REFERENCE TO RELATED APPLICATIONS

This application claims the benefit of U.S. Provisional Patent Application No. 61/283,822, filed Dec. 9, 2009, the disclosure of which is incorporated herein by reference in its entirety.

### STATEMENT REGARDING FEDERALLY SPONSORED RESEARCH OR DEVELOPMENT

Non-applicable

### BACKGROUND OF THE INVENTION

(1) Field of the Invention

The present disclosure relates to systems and methods for finding a vehicle.

(2) Description of Related Art

Direction finding has been around for a long time. Some solutions depend on the determination of position via the Global Positioning System (GPS) at two points. The direction is computed from the position vector formed between the two points. Non-GPS based direction finding techniques have been tested that determine the direction of a radio frequency signal by receiving it through a circular array of antenna elements. Algorithms such as the Analog Single Channel (A-SCPD) and Digital Phase Lock Loop (D-PLL) have been developed. These systems have been unsuccessful in more complex reflecting environments such as parking lots and parking garages.

A need still exists for technology operable for a direction finder device that allows for immediate directional location of a vehicle, particularly in complex reflecting environments. A further need exists for convenient and low cost technology for use in car finding systems.

### OBJECTS

It is an object of the present invention to provide a direction finding system that allows for wirelessly finding a vehicle. These and other objects will become increasingly apparent by reference to the following description.

### SUMMARY OF THE INVENTION

The present invention provides for a system for locating a vehicle which comprises: (a) a transmission device for transmission and receiving of a signal which comprises a plurality of indicators arranged in a plurality of angular locations relative to a reference point, the transmission device is adapted to be held by a user and transmit a radio frequency or microwave frequency transmission signal; (b) an antenna array positioned on or in a vehicle, the array comprising a plurality of antennas arranged in a plurality of angular locations relative to a reference point, the array is adapted to receive the transmission signal from the transmission device at each antenna; (c) a microcontroller unit adapted to: (i) receive digital data converted from the transmission signal, (ii) calculate an angle of arrival (AOA) or direction of arrival (DOA) based on known components and an algorithm; and (iii) transmit a signal back to the transmission device to indicate the AOA or DOA on the indicators; and (d) a signal processing unit comprising a switch to alternate between each antenna to obtain a signal transmission at each antenna one by one, and provide signal conversion, wherein the signal processing unit is coupled to the plurality of antennas and the microcontroller unit, and wherein the signal processing unit is adapted to receive the signal transmission from each antenna one by one, convert the signals to digital data, and transmit the digital data to the microcontroller unit. The algorithm is selected from the group consisting of an analog single channel pseudo-doppler algorithm (A-SCPD), a digital phase lock loop algorithm (D-PLL), and a received power level algorithm (RPL). In a particular embodiment, the algorithm is a received power level algorithm (RPL) adapted to calculate the power level at each antenna, select the antenna receiving the highest power, and transmit a signal to the transmission device to activate the indicator corresponding to the highest receiving power antenna which indicates the direction of the antenna array with respect to the transmission device. The plurality of indicators and/or the plurality of antennas can include a number of indicators/antennas ranging from 4 to 8, 12, or 16. The indicators/antennas are suitably arranged circumferentially (e.g., in a circular pattern) around their reference point, for example spaced apart at angles of at least 2°, 5°, 10°, or 15° and/or up to 30°, 45°, 60°, or 90°, which angles can be the same or different for adjacent indicators/antennas in the pluralities. In an example, the indicators and antennas have the same configuration in terms of numbers and spacing. In a further embodiment, the antenna array comprises 8 directional antennas arranged in a circular configuration spaced apart 45° with respect to each other.

The microcontroller unit is adapted to receive digital data converted from the transmission signal, calculate a power level for each antenna in the array, sort the antennas according to each antenna's power level, and cause the antenna selected with the highest probability of receiving the transmitted signal to transmit a signal back to the transmission device to cause one of the plurality of indicators to turn on, wherein the indicator that is turned on is associated with the direction of the vehicle with respect to the transmission device. The system is operable to calculate a substantially accurate DOA in any environment selected from the group consisting of an open field, a parking lot filled with other vehicles, and a parking garage filled with other vehicles and having walls and other structures. The antennas can be adapted to operate at a half-power beam width (HPBW) of 45°, 90°, and 135°. The DOA estimates can fall within a threshold value ranging from about 22.5° to 67.5°. The system can achieve DOA estimates of at least 40% pass rate for a 22.5° threshold and at least 70% pass rate for 67.5° threshold in a parking garage or open parking environment.

In an even further embodiment, the array of antennas comprises 4 to 8 antennas. The antennas are conFIG.d in a circular array defining a radius from about a quarter-wavelength to a half-wavelength. The transmission device is operable to transmit a signal at a wavelength ranging from about 915 MHz to 2.4 GHz. The antenna array can be placed on an exterior roof of the vehicle substantially in the center of the roof or on an interior of the vehicle substantially mounted to the center of the roof. In an exemplary embodiment, the transmission device is a key fob and the indicators are light emitting diode (LED) indicators, wherein the LED indicators are arranged in a circular pattern and correspond to the number of antennas mounted on the vehicle. Typically, the antenna array is mounted in a metal housing comprising metallic side-walls positioned between the individual antennas and having a top and bottom surface positioned above and below the antennas respectively and the antennas align parallel to an axial axis through the center of the housing.

The present disclosure provides for a method for finding a vehicle comprising the steps of: (a) transmitting a radio frequency or microwave frequency signal from a transmission device to an antenna array positioned on or in a vehicle, wherein the array comprises a plurality of antennas arranged in a plurality of angular locations relative to a reference point adapted to receive a transmission signal from the transmission device, and wherein the transmission device comprises a plurality of indicators arranged in a plurality of angular locations relative to a reference point and is adapted to be held by a user; (b) processing the transmission received by the antenna array through a signal processing unit comprising a switch to alternate between each antenna to obtain a signal transmission at each antenna one by one, wherein the signal processing unit is coupled to the plurality of antennas and a microcontroller unit, wherein the signal processing unit is adapted to receive the signal transmission from each antenna one by one, convert the signals to digital data, and transmit the digital data to the microcontroller unit; (c) calculate an angle of arrival (AOA) or direction of arrival (DOA) with the microcontroller unit based on predetermined values and an algorithm using the digital data from the signal processing unit; and (d) transmitting a signal based on the AOA or DOA to the transmission device to activate at least one of the indicators to direct the user towards the vehicle. In a particular embodiment, the algorithm is a received power level algorithm (RPL) that calculates the power level at each antenna, selects the antenna receiving the highest power, and transmits a signal to the transmission device to activate the indicator corresponding to the highest receiving power antenna which indicates the direction of the antenna array with respect to the transmission device.

The present disclosure further provides for a direction finder apparatus comprising: (a) an antenna array adapted to be mounted on or in an object, the array comprising a plurality of antennas arranged in a plurality of angular locations relative to a reference point adapted to receive a radio frequency or microwave frequency transmission signal from a transmission device; (b) a metal housing comprising (i) metallic side-walls positioned between the individual antennas, and (ii) a top and bottom surface positioned above and below the antennas respectively. The antennas are aligned parallel to an axial axis through the center of the housing. The antenna array is coupled to a signal processing unit comprising a switch to alternate between each antenna to obtain a signal transmission at each antenna one by one and provides signal conversion, and coupled to a microcontroller unit for processing the transmission signal and transmitting a signal back to the transmission device to indicate the direction of the object. In a particular embodiment, the object is a vehicle. In a further embodiment, the object is adapted to be carried or removably mounted on a person. For example, the person can be a child and the apparatus is used to help find that child in a desired location like an amusement park.

The present disclosure provides for a system for locating an object or location which comprises: (a) a transmission device for transmission and receiving of a signal which comprises a plurality of indicators arranged in a plurality of angular locations relative to a reference point, the transmission device is adapted to be held by a user and transmit a radio frequency or microwave frequency transmission signal; (b) an antenna array positioned on an object or at a location, the array comprising a plurality of antennas arranged in a plurality of angular locations relative to a reference point, the array is adapted to receive the transmission signal from the transmission device at each antenna; (c) a microcontroller unit adapted to: (i) receive digital data converted from the transmission signal, (ii) calculate an angle of arrival (AOA) or direction of arrival (DOA) based on known components and an algorithm; and (iii) transmit a signal back to the transmission device to indicate the AOA or DOA on the indicators; and (d) a signal processing unit comprising a switch to alternate between each antenna to obtain a signal transmission at each antenna one by one, wherein the signal processing unit is coupled to the plurality of antennas and the microcontroller unit, and wherein the signal processing unit is adapted to receive the signal transmission from each antenna one by one, convert the signals to digital data, and transmit the digital data to the microcontroller unit. In an exemplary embodiment, the algorithm is a received power level algorithm (RPL) adapted to calculate the power level at each antenna, select the antenna receiving the highest power, and transmit a signal to the transmission device to activate the indicator corresponding to the highest receiving power antenna which indicates the direction of the antenna array with respect to the transmission device.

### BRIEF DESCRIPTION OF THE DRAWINGS

FIG. 1 illustrates a modeling methodology for the Pseudo-Doppler Direction Finding (PD-DF) algorithm on a vehicle in an open field at 915 MHz.

FIG. 2 illustrates an open field wireless channel model from WIRELESS INSITE.

FIG. 3 illustrates a block diagram of the Single Channel Pseudo-Doppler (SC-PD) system.

FIG. 4 is a graph that illustrates percent of true estimation as a function of receiver antenna array location in an open field environment using the A-SCPD algorithm.

FIG. 5 is a graph that illustrates the relative error percentage between simulation results and measurements for the average error values and the pass rate in the open field environment using the A-SCPD algorithm.

FIG. 6 illustrates a model of an open parking lot scenario.

FIG. 7 illustrates a model of a parking garage scenario.

FIG. 8 is a graph that illustrates pass rate performance of the Analog, PLL and RPL algorithms in the open field scenario.

FIG. 9 is a graph that illustrates pass rate performance of the Analog, PLL and RPL algorithms in the open parking lot scenario.

FIG. 10 is a graph that illustrates pass rate performance of the Analog, PLL and RPL algorithms in the parking garage scenario.

FIG. 11 illustrates a model of a car with an antenna array mounted on the roof.

FIG. 12 illustrates an RPL method system level diagram.

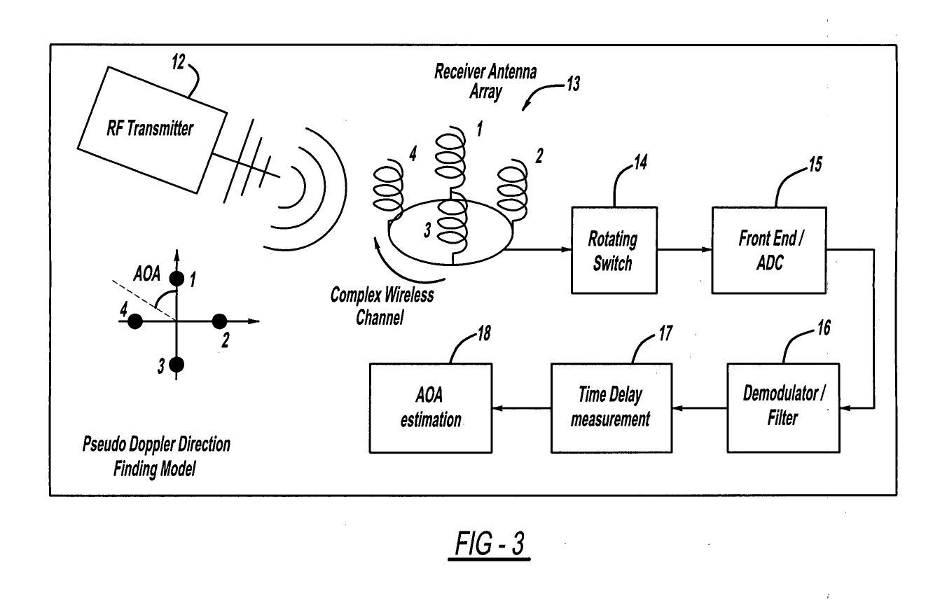

FIGS. 3A and 13B illustrate an exemplary metal housing antenna array embodiment.

FIG. 14 illustrates an antenna array 3D gain radiation pattern when one antenna element is active.

FIG. 15(a)-15(b) illustrates the azimuth with θ=90° and elevation with φ=22.5° gain pattern cuts.

FIG. 16 illustrates a SIMULINK model of the car finder system signal processing chain.

FIG. 17 illustrates a selection schemes used within the RPL method; (a) +/−22.5°, and (b) +/−67.5°.

FIG. 18 illustrates simulation results for the RPL in two complex environments.

### DESCRIPTION OF PREFERRED EMBODIMENTS

All patents, patent applications, government publications, government regulations, and literature references cited in this specification are hereby incorporated herein by reference in their entirety. In case of conflict, the present description, including definitions, will control.

### DEFINITIONS

PD-DF—Pseudo-doppler direction finding
PD—Pseudo-doppler
DF—Direction finding
RPL—Received power level method
PLL—Phase locked loop
COTS—Cost of the shelf
DOA—Direction of arrival
SBR—Shooting and bouncing rays
SC-PD—Single channel pseudo-doppler
AOA—Angle of arrival
RF—Radio frequency
IF—Intermediate frequency
Hz, KHz, MHz, and GHz—Hertz, Kilohertz, Megahertz, and Gigahertz
BPSK—binary phase shift keying
LED—Light emitting diodes
LOS—Line of sight
A-SCPD—Analogue single channel pseudo-doppler
D-PLL—Digital phase lock loop
DFT—Discrete Fourier transform
HPBW—Half-power beam widths
ADC—Analogue to digital converter
MCU—Microcontroller unit

The present disclosure provides for apparatus, systems, and methods of finding objects. Although the particular disclosure provided is directed to vehicle direction finding, the applicable algorithms and embodiments can be applied to other applications that are within the scope of this disclosure. For example, the systems and apparatus can be used as a child finding system and apparatus. This is particularly useful in an amusement park, entertainment venue, or any other public environment.

In an example, a direction finder system was modeled and then evaluated for 915 MHz and then evaluated for 2.4 GHz. Using the algorithms described hereinbelow; a system can be constructed using various frequencies that range between 900 MHz and 2.5 GHz. The modeling effort was organized into three sub-tasks: Section (1) Car Finder Algorithm Model Development and Validation; Section (2) Car Finder Algorithm Optimization; and Section (3) Car Finder System-Level Model Development. Section (3) can developed using a suitable software program such as SIMULINK or the like.

In an example of section (1), a signal processing model for the analog pseudo-doppler direction finding (PD-DF) algorithm as well as an open field wireless environment were developed using MATLAB and WIRELESS INSITE, respectively. The two models are integrated, and then the full model results are compared against the open field measurements that were provided to access the fidelity and to validate the accuracy of the created model.

In an example of section (2), two alternative algorithms were introduced that were investigated to optimize the performance of the PD-DF algorithm modeled in section (1). The digital phase locked loop (PLL) and the received power level method (RPL) were the two methods modeled. Also, two more complex wireless environments were investigated; an open parking lot and a parking garage. The modeling and simulation results were compared in these environments, and two receiver locations were of interest: (i) exterior top center location of the vehicle and (ii) the interior center location of the vehicle.

The RPL method showed better pass rate in the complex environments compared to phase based methods (PD and PLL). Accordingly, in section (3), a full system model for the RPL is presented. IN this example, the design and simulation of a compact size antenna array as well as the signal processing chain were modeled in the software products FEKO and SIMULINK, respectively. Two selection algorithms for the RPL were also presented and their results were compared.

### Section (1) Example

### Car Finder Algorithm Development and Validation in MATLAB

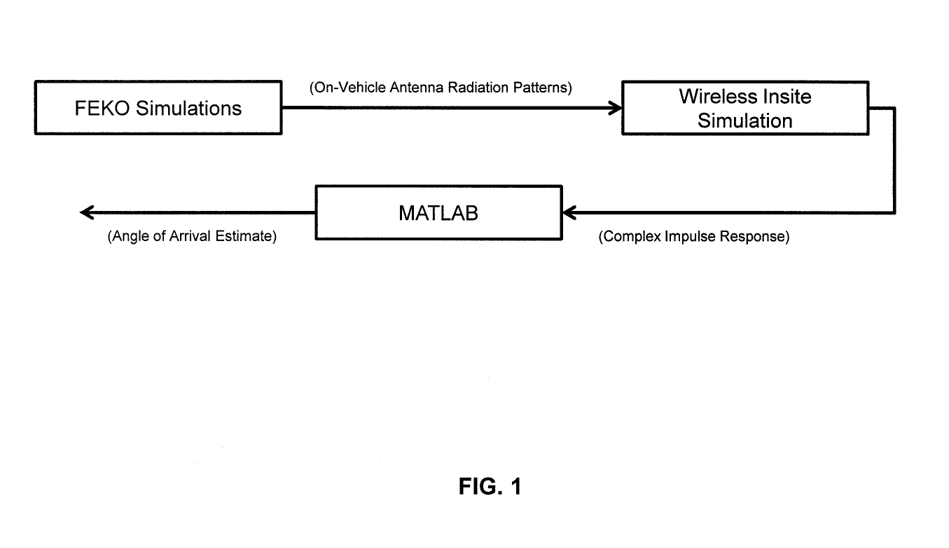

A three-stage modeling approach was undertaken as depicted in FIG. 1. First, a first commercial-off-the-shelf (COTS) software package (e.g., FEKO) was utilized to create three-dimensional radiation patterns for receiving antennas on a vehicle. A four element antenna array (i.e., four antennas) were modeled and positioned in various angular locations with respect to a reference point. The exported three dimensional radiation patterns were then input into a second COTS software package (e.g., WIRELESS INSITE). The package, WIRELESS INSITE, was used to calculate the complex impulse response of a channel from a transmitter to each of the receiving antenna elements for a particular reflecting environment. The received complex electric fields at each of the receiving antenna elements were subsequently input to the direction finding algorithm, implemented in MATLAB, to arrive at a direction of arrival (DOA) estimate.

Antenna Pattern Modeling using (e.g., FEKO)—The COTS software package FEKO, a 3-dimensional full-wave field solver based on the method of moments, was used to model the radiation pattern of the receiving antennas that were placed on the vehicle. FEKO was utilized to model the component-level radiation pattern of the 4-element receiving antenna array. Spring antennas were used. The spring antenna was modeled as a quarter-wave monopole since it produces a similar radiation pattern for vertical polarization. The radiation model simulation was based on the antenna array in isolation.

Channel Modeling (e.g., WIRELESS INSITE)—The COTS software package WIRELESS INSITE was used to characterize the propagation channel for the pseudo-doppler direction finding (PD-DF) system at 915 MHz. WIRELESS INSITE is a tool used for modeling the effects of buildings and terrain on the propagation of electromagnetic waves. It can be used to predict how the locations of transmitters and receivers within an urban area affect the signal strength. Physical characteristics of rough terrain and urban structures were modeled, electromagnetic calculations were performed, and signal propagation characteristics were evaluated.

Reflecting Environment—The targeted reflecting environment was a vehicle parked in an open field. The electrical properties for the open field (dry soil) and the vehicle (perfect electric conductor and rubber) are taken into account. This allows for the collection of base line data with generally very little interference or reflections from the environment. It provides a base model for the behavior of the antenna array in isolation.

Waveforms—A waveform with a carrier frequency of 915 MHz and a bandwidth of 1 MHz was chosen in this simulation.

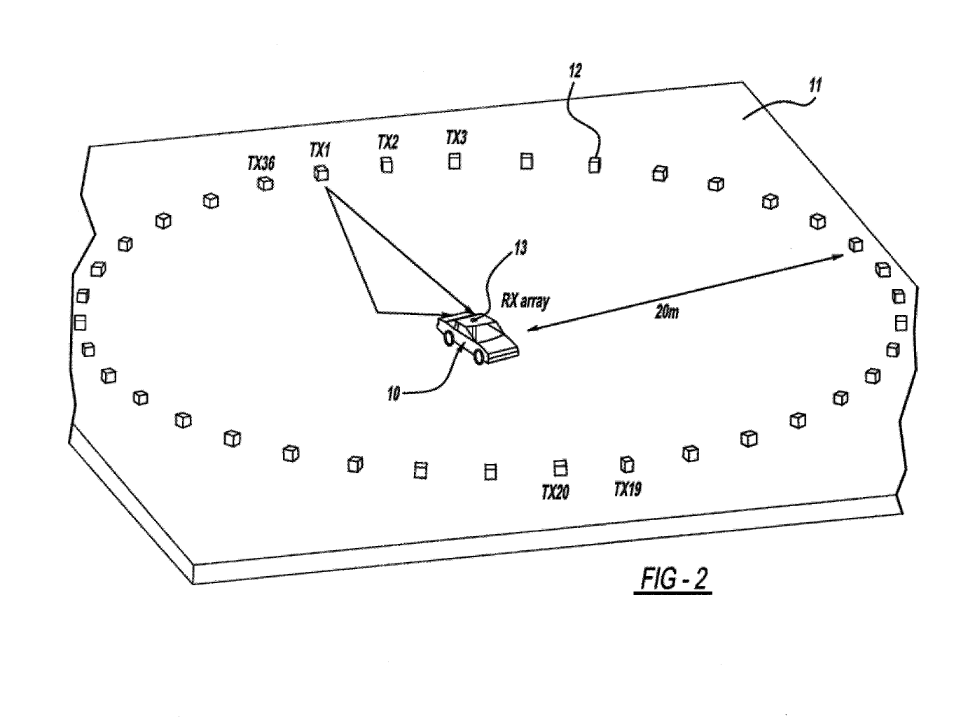

Transmitters—For modeling purposes, thirty six transmitters were placed in a circle with a radius with 20 meters (See e.g., FIG. 2) centered with respect to the center of the 4-element receiving antenna array and a height of 1.2 meters. Each transmitter radiated a waveform at 915 MHz and possessed a short vertical dipole antenna. In FIG. 2 an example simulation is illustrated. A vehicle 10 is positioned in the center of an open field area 11 surrounded by a circular array of thirty six transmitters 12 at a radius of about 20 meters. A 4-element receiving antenna array 13 is positioned on the vehicle and serves as a center basis for transmission.

Receivers—Four receivers (i.e., antennas) were chosen for this simulation corresponding to the four receiving antenna array 13 of the circular array. The four receiving antennas are placed in a circular array with a radius of a quarter-wavelength. The 4-element receiving antenna was placed at four distinct locations on the vehicle: 1) exterior center of roof, 2) interior front roof, 3) interior center roof, and 4) interior rear roof. All locations run along the centerline of the roof. In addition, a quarter-wave monopole was selected as the receiving antenna. A quarter-wave monopole's radiation pattern exhibits an azimuthally omni-directional amplitude and phase pattern.

Study Area—Now that the entire wireless channel was defined, a full ray tracing solver utilizing shooting and bouncing rays (SBR) was selected to determine the received complex impulse response of this channel. The ray interactions were limited to direct rays, and rays with one reflection reflected ray and/or one diffracted ray. The amplitude, phase and time of each ray that contribute to the total power received at a single receiver from a single transmitter was available.

These complex power vectors were passed to the SC-PD algorithm MATLAB code for AOA estimation. A rotating switch was used to activate only the incoming RF signal from a single antenna at a time. The received complex voltage at the output of the i^{th} antenna was given by:

Vᵢ=E_{θ,i}g_{θ}(θᵢ,φᵢ)+E_{φ,i}g_{φ}(θᵢ,φᵢ) (1)

where, E_{θ,i}, E_{φ,i} are the elevation and azimuth electric field components for the i^{th} antenna, respectively. The terms g_{θ}(θᵢ, φᵢ), g_{φ}(θᵢ, φᵢ) are the elevation and azimuth gain values for the i^{th} antenna, respectively. The E-fields in (1) are the sum of the incoming fields from the wireless channel. Thus, the total incoming power at the i^{th} antenna is given by:

$${P}_{Total , i} = {\sum }_{j = 1}^{K} {P}_{R , i} ( k ) \qquad ( 2 )$$

where, K is the total number of incoming E-filed rays at the i^{th} antenna.

SC-PD Direction Finding Algorithm Modeling (MATLAB)—The receiver architecture of the SC-PD algorithm is shown in FIG. 3. The incoming RF transmitter signal impinges on the 4-element antenna array, and the output of one antenna at a time is passed to the receiver module. An RF rotating switch gives the output of each antenna to be analyzed for T_{sw}/4, where T_{sw} is the period of the rotating switch. The antennas are not physically rotated but rather the rotating switch is used to switch between antennas. The incoming signal at the i^{th} antenna can be described as:

$${r}_{i} ( t ) = m ( t ) cos ( {ω}_{o} t + {θ}_{o} + \frac{2 π r}{λ} cos ( \frac{2 πi}{Na} - Φ ) ) + {n}_{i} ( t ) \qquad ( 3 )$$

where m(t) is the modulating message signal (i.e., contains information), and BPSK is the modulation of choice for such an application. The term ωₒ is the carrier radian frequency, λ is the wavelength, r is the circular array radius, Nₐ is the array antenna elements, and φ is the AOA. The term nᵢ(t) is the noise in the antenna path inside the receiver.

The implementation of the PD algorithm was performed using MATLAB. The implemented algorithm (pseudo-code) is presented in Table 1 and the block diagram is shown in FIG. 3. The incoming RF signal is sampled using a rotating switch 14 that passes the output of a single antenna from the array to the receiver module 15 such as a front end/ADC at a time. This adds a phase component to the incoming RF signal on top of the phase from the complex impulse response of the channel which includes all phase effects due to signal path delay, reflection, diffraction and antenna phase pattern. The continuous input RF signal is then converted to IF and passed to a phase demodulator 16. The output of the phase demodulator 16 is filtered, thus giving a sinusoidal output that has a time delay 17, τ, with respect to the rotating switch phase, φ, which is shown as:

τ=f(φ) (4)

TABLE 1
Pseudo-Code for the SC-PD algorithm.
Pseudo Doppler Algorithm

```
Set Parameters:
  RotatingSwitchFrequency, IF, InternAntennaSpacing, No. Antennas,
  SamplingFrequency,FilterTypeAndOrder
Create a CW Signal
Create the complex channel and antenna response for each array element
per Azimuth Angle
For i=1:TPI
  Generate PM signal with channel and antenna effects
End
Demodulate incoming PM signal
Filter Signal
Signal process demodulated signal and compare against reference signal
Determine AOA based on time delay estimates
```

Time delay (τ) is measured against the rotating switch 14 frequency in order to perform a time-delay estimate (performed inside a microcontroller in hardware). Since the period of the rotating switch is known, as well as the time delay estimate, an AOA can be calculated as shown in AOA estimation box 18. The results are then sent back to the user handheld device and an indicator, such as an LED, is activated or lit. For validation purposes, the receiver unit was modeled and implemented, and the AOA estimate was shown in an on-vehicle module.

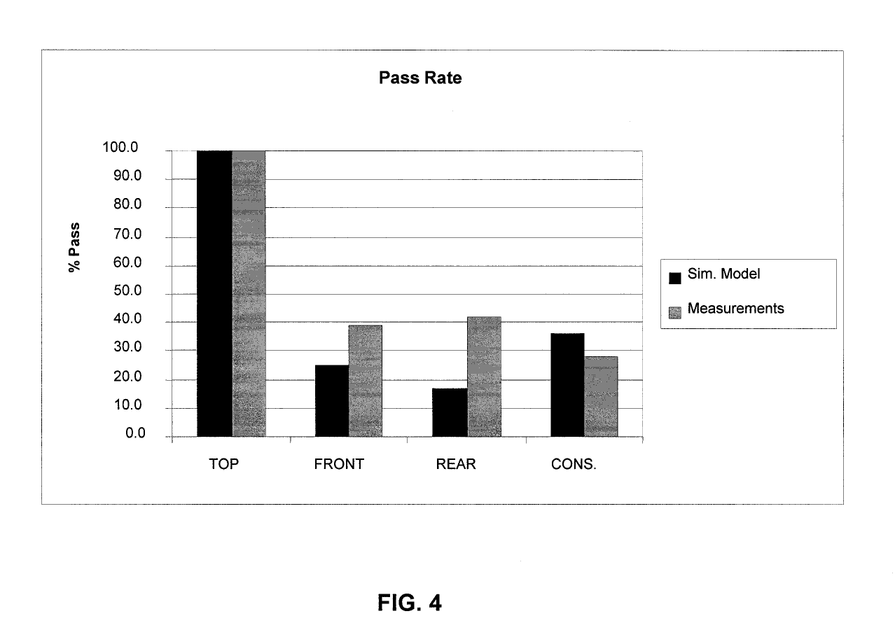

Results—An exemplary comparison was evaluated of the DOA estimation results from the mathematical model and the hardware prototype in the scenario (see FIG. 2) in which the 4-element receiving antenna array 13 was placed in four locations on a sedan 10 located in an open field 11. Thirty-six transmitters 12 were uniformly spaced around a circle with a radius of 20 meters at a height of 1.2 meters were measured and modeled. The PD-DF algorithm in MATLAB was selected to have a sampling frequency of 915 KHz and an intermediate frequency of 91.5 KHz for computational simplicity. The rotating switch frequency was 750 Hz and the phase modulator was followed by a bandpass filter with a center frequency equivalent to the frequency of the rotating switch and a band width of 6 Hz. Results are summarized in Table 2. FIG. 4 represents a chart of the results in a manner that takes into account how the DF system would be used in an application.

TABLE 2
Error Statistics (degrees) for all receiver locations.

| | Exterior Roof Center | | Interior Front Roof | | Interior Back Roof | | Interior Center Roof | |
|---|---|---|---|---|---|---|---|---|
| | Simulation | Measurement | Simulation | Measurement | Simulation | Measurement | Simulation | Measurement |
| AVG. | 4.5 | 4.2 | 76.5 | 49.2 | 73.7 | 60.6 | 61.7 | 64.0 |
| STD. | 4.2 | 3.2 | 51.2 | 45.1 | 43.9 | 57.9 | 52.3 | 53.1 |
| MIN. | 0.5 | 0.0 | 2.9 | 0.0 | 4.3 | 0.0 | 2.2 | 0.0 |
| MAX. | 21.2 | 14.0 | 172.3 | 180.0 | 174.7 | 180.0 | 177.3 | 180.0 |
| % pass | 100.0 | 100.0 | 25.0 | 38.9 | 16.7 | 41.7 | 36.1 | 27.8 |

In an exemplary embodiment, eight light emitting diodes (LEDs) are placed substantially in a circular pattern on a hand held device to indicate a distinct direction towards the vehicle. Each sector separated by each LED covers 45 degrees and thus as long as the error is within +/−22.5 degrees then the correct LED would be illuminated. A score of 100% implies all 36 transmitters passed the criteria of not exceeding +/−22.5 degrees AOA accuracy. All angles were referenced to the north pole. As shown in Table 2 and FIG. 4, both the simulation model and the measurements show 100% pass rate (correct AOA estimation) for the exterior center location, while the simulation model provides a rather more pessimistic rate for inside the car. Both simulations and measurements failed to give reliable AOA estimate inside the car due to the lack of a direct line of site (LOS) with the transmitter. When analyzing the complex impulse response for transmitter locations that exhibited large AOA estimates, it was determined that two situations existed. No direct ray exists in one situation while in the other scenario a direct ray exists but second strongest ray was less than 15 dB in amplitude than with respect to the direct ray. This degraded the LOS phases.

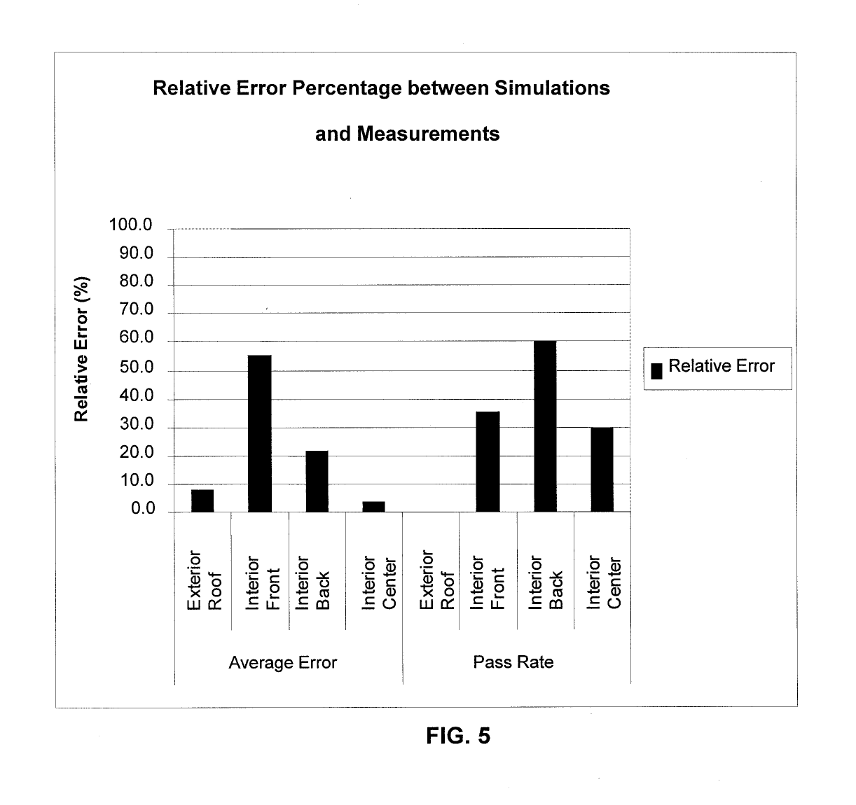

FIG. 5 shows a chart of the relative error percentage between the simulation results and the measurements for the 4 different receiver locations of the vehicle. It is evident that close estimates are obtained for the exterior case with less than 10% for both the average errors and pass rates. The average error and pass rate for the interior receiver locations varied significantly between the simulation model and the measurements with the simulation model giving better passing rates while showing a little more pessimistic average errors per location than measurements. This noticeable deviation is due to the differences between the modeled and simulated car model and materials. Even with such differences, the model was able to show clearly that the interior locations would not pass the required accuracy percentage, which correlated with field measurements.

Conclusions—A high fidelity SC-PD-DF model of a vehicle localization system was developed that was based on the algorithm used in a car finder hardware prototype. The model consisted of a wireless channel model and a software receiver model. The accuracy of the model was validated against a hardware prototype system of a DOA system that utilized a 4-element antenna array 13 placed at four different car locations. The model and the prototype exhibited excellent correlation with each other for all four antenna locations. Furthermore, the results for both simulation and measurements indicated that interior vehicle antenna array locations performed worse than an exterior roof location. This validated tool was used for the optimization of the DF algorithm for two complex reflecting environments described in Section (2).

### Section (2) Example

### Car Finder Algorithm Optimization

The validated mathematical approach described above was used to optimize the car finder's performance in the presence of three complex environments. The three different DF algorithms, the three environments in which the algorithms were exposed, and the performance of the algorithms is described below.

Direction of Arrival Estimation Algorithms—Three DF algorithms were evaluated. The analog SC-PD algorithm used in Section 1 was implemented in the car finder hardware prototype. The performance of this algorithm in field testing exhibited poor performance in complex reflecting environments. Improving the performance of this algorithm is desired. This method optimizes the performance of the phase-based DF algorithm and it can be implemented based on a digital phase locked loop (PLL) architecture. The third approach, based on received power level, was proposed as a backup approach in case the optimized phase-based approach did not render acceptable results.

Analog Single Channel Pseudo-Doppler Algorithm (A-SCPD)—This DF approach is based on processing the received phases from four antennas placed in a circular array on the vehicle. The four received phases are processed to produce a DOA estimate based on the scheme described in [D. Peavey and T. Ogumfunmi, “The Single Channel Interferometer Using A Pseudo Doppler Direction Finding System,” IEEE Proceedings of the International Conference on Acoustics, Speech and Signal Processing, Vol. 5, pp. 4129-4132, April 1997; and RDF Products, “A Comparison of the Watson-Watt and Pseudo-Doppler DF Techniques,” White paper WN-004, Rev. B-01, April 1999]. The algorithm used is described in section (1).

Digital Phase Lock Loop Algorithm (D-PLL)—A digital PLL algorithm (using the discrete Fourier transform (DFT)) was implemented and described in [N. Harter, et. al., “Analysis and Implementation of a Novel Single Channel Direction Finding Method,” IEEE Proceedings of Wireless Communications and Networking Conference, Vol. 4, pp. 2530-2533, March 2005; N. Harter, et. al., “Development of a Novel Single Channel Direction Finding Method,” IEEE Proceedings of the Military Communications Conference, Vol. 5, pp. 2720-2725, October, 2005]. This approach was implemented using four receiving antennas placed in a circular array with a diameter of one-half wavelength. The four received phases were processed using the DFT to produce an estimate of the DOA.

Received Power Level Algorithm (RPL)—This approach deviates from the previous DF schemes in that it utilizes a circular array of eight directional antennas on the vehicle. The antenna capturing the most power is assumed to be the DOA. Eight antennas were chosen because when uniformly placed in a circular array they are spaced apart by 45 degrees with respect to each other. Three directional antennas are assessed in this task based on half-power beam widths (HPBW) of 45, 90 and 135 degrees. The impact of the antenna's HPBW on DOA accuracy is substantial because it yields the performance criteria for the antenna that is needed to make it operational. The cost and size restraints can then be taken into account based on the required performance.

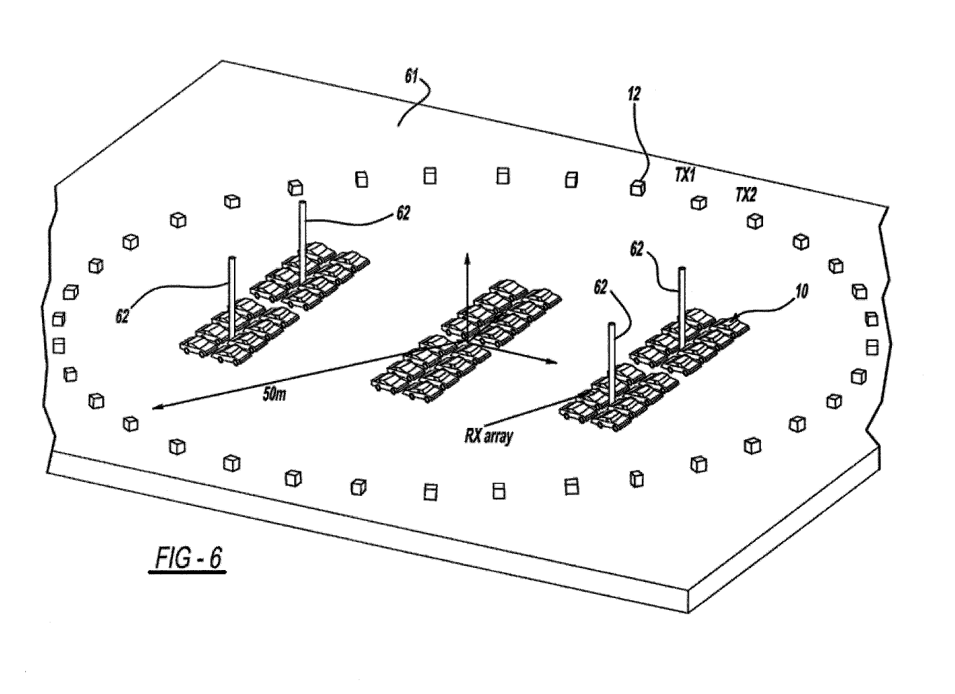

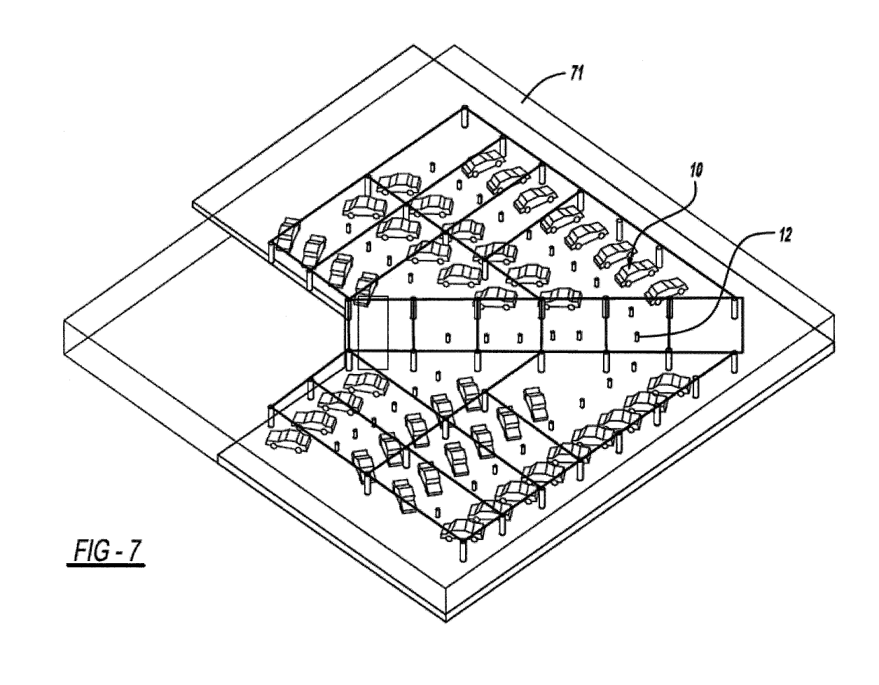

Simulation Environments—The three DF algorithms described herein were tested in three different environments with increasing complexity: (i) An Open Field 11 (Simple) as shown in FIG. 2; (ii) An Open Parking Lot 61 (Medium/Difficult) as shown in FIG. 6; and (iii) A Parking Garage 71 (Difficult) as shown in FIG. 7.

All three simulations had thirty six transmitters 12 and four antenna elements for the A-SCPD and the D-PLL algorithms and eight antenna elements for the for the RPL algorithm. The transmitters and receivers utilized vertical dipoles and quarter-wave monopoles, respectively. The four receiving antennas were placed in a circular array with a diameter of one-half wavelength. The 4-element antenna array was placed at two locations on the vehicle 13: 1) exterior center roof top and 2) interior center roof console. The radiating signal was a carrier wave at 2400 MHz with a bandwidth of 1 MHz and a power level of 1 milli-watt.

Open Field—The open field environment, as depicted in FIG. 2, was initially used since a simulation run time that was relatively short and could be run on a single core desktop computer.

Open Parking Lot—The Open Parking Lot scenario was comprised of flat concrete terrain with 24 HONDA ACCORDS, 24 JEEP CHEROKEES, and four light posts 62 as depicted in FIG. 6. The receiving antenna array was placed in row five and column 2 with respect to the lower left hand corner of the vehicles shown in FIG. 6. Typically, the array was located on the roof of the vehicle, generally in the center of the roof.

Parking Garage—The Parking Garage scenario (FIG. 7) contained significantly more objects than the open parking lot scenario. The ceiling and floor of the parking garage scenario were made of concrete. Thirty two concrete support posts were placed throughout the parking garage scenario. Next, 47 HONDA ACCORD vehicles were placed in the parking garage. The receiving antenna array was placed in row one and column 2 with respect to the upper left hand corner of the vehicles shown in FIG. 7.

Results—The performance of the three DF approaches was scored based on the pass rate. The pass rate is defined as the number of DOA estimates that fell within a certain threshold divided by thirty six (i.e. number of transmitters). Threshold values of 22.5 degrees and 67.5 degrees were explored. The results for the open field, open parking lot, and the parking garage are described below.

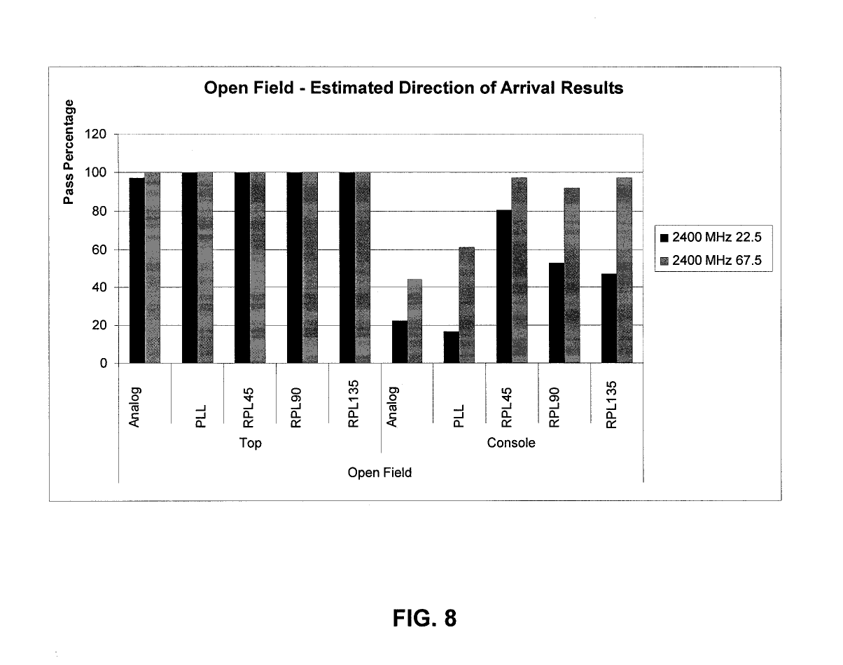

Open Field—The open field is a relatively benign environment. The results in FIG. 8 show that all three algorithms perform exceptionally well when the receiving antenna array is placed on top of the roof. Furthermore, the results indicate all three algorithms perform significantly worse when the receiving antenna array is placed inside the vehicle. When the antenna array is placed within the vehicle, the RPL with HPBW of 45 degrees performs the best while the PLL algorithm performs the worst when utilizing the 22.5 degree criterion.

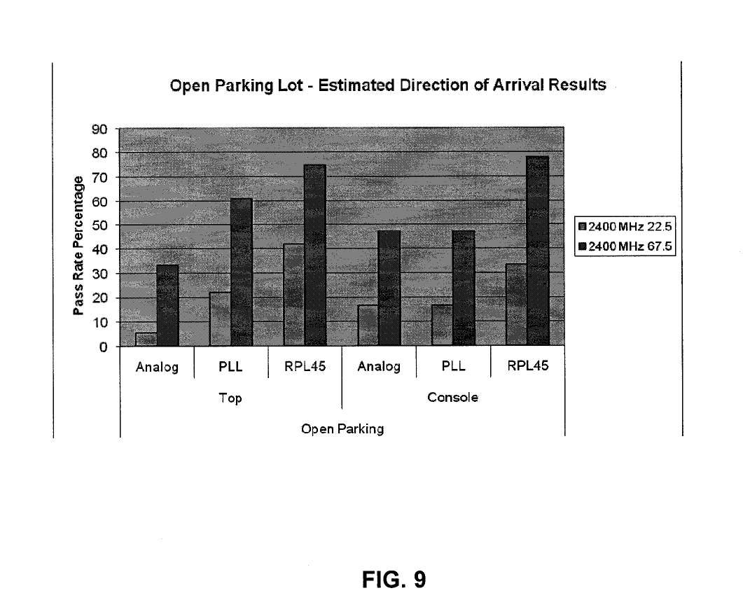

Parking Lot—The open parking lot scenario presents a challenging reflecting environment to all three DF algorithms (FIG. 9). The RPL algorithm performed the best and the analog algorithm performed the worst for both antenna locations. The PLL approach performed better than the analog approach for the top location but performed comparable for the console location. For the top location, the pass rate for the RPL algorithm was approximately 40% and 75% for accuracies of 22.5 degrees and 67.5 degrees, respectively. These results are significantly better than the results obtained for the analog and PLL DF approaches. The RPL algorithm performed best when placed on top of the roof.

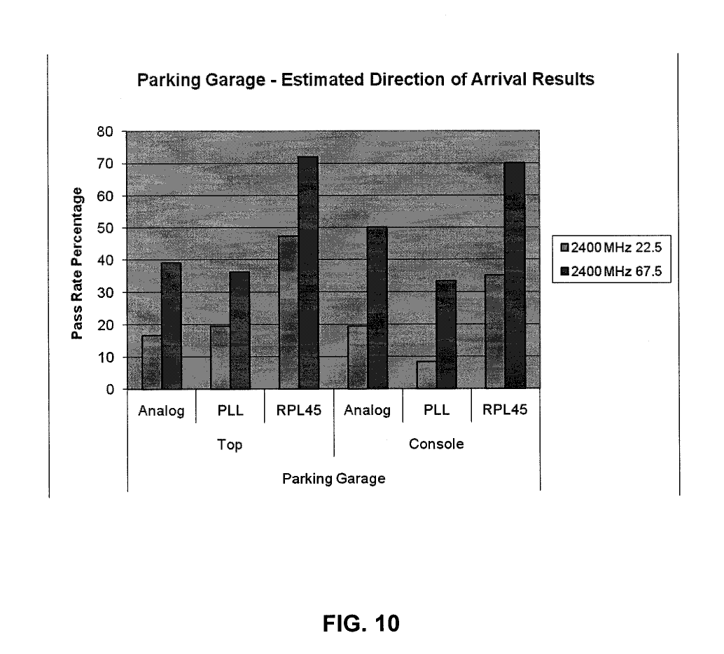

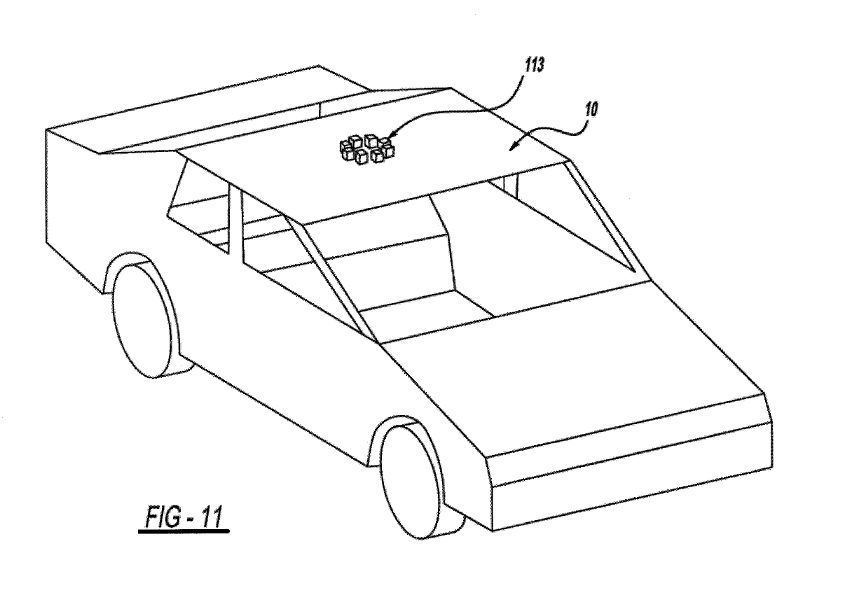

Parking Garage—The parking garage scenario presented another harsh environment to the three DF algorithms (FIG. 10). Again, the RPL algorithm significantly outperformed the analog and PLL algorithms. For this scenario, the analog outperformed the PLL algorithm. However, both the analog and the PLL performance were not up to par. The location of the receiving antenna did not impact the performance significantly for all three algorithms as it had done in the open field and the open parking lot scenarios.

Conclusions—The following conclusions were drawn: (i) The analog and PLL phased-based DF algorithms were not acceptable in complex environments; (ii) The RPL-DF algorithm performed at a 75% pass rate in the open parking lot and parking garage scenarios when the antenna array was placed on top of the roof; and (iii) The RPL algorithm's performance is optimal when the HPBW of the directional antennas that comprise the 8-element circular array approaches 45 degrees.

### Section (3) Example

### Car Finder Algorithm Development in SIMULINK

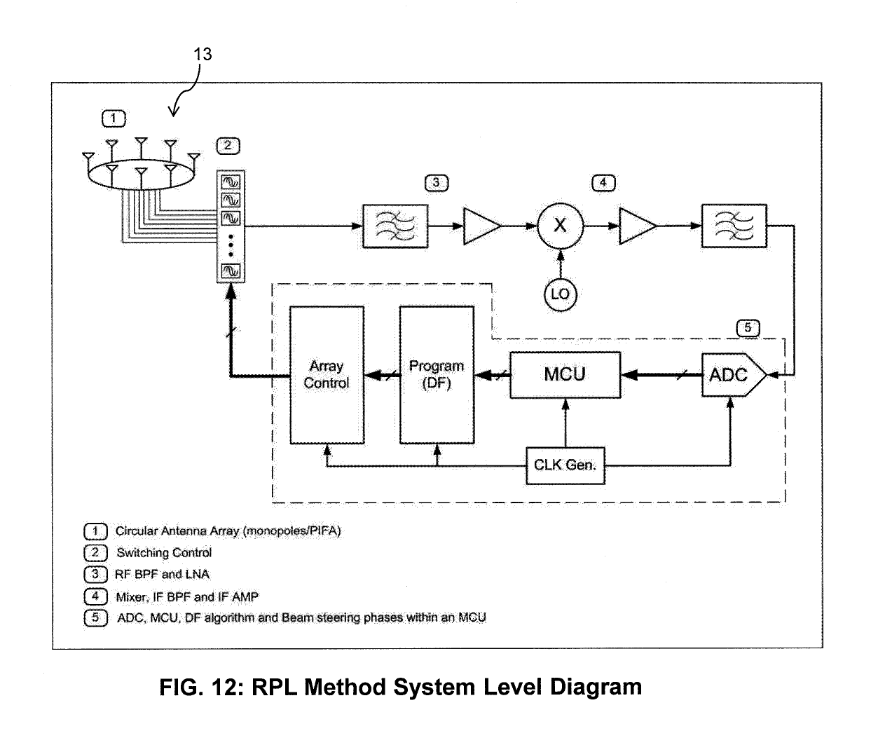

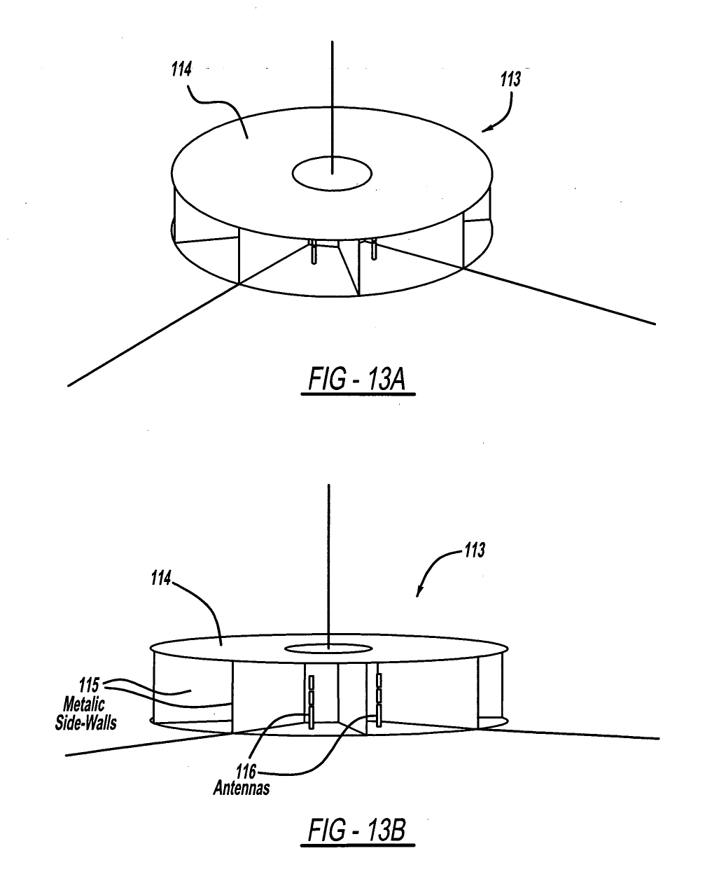

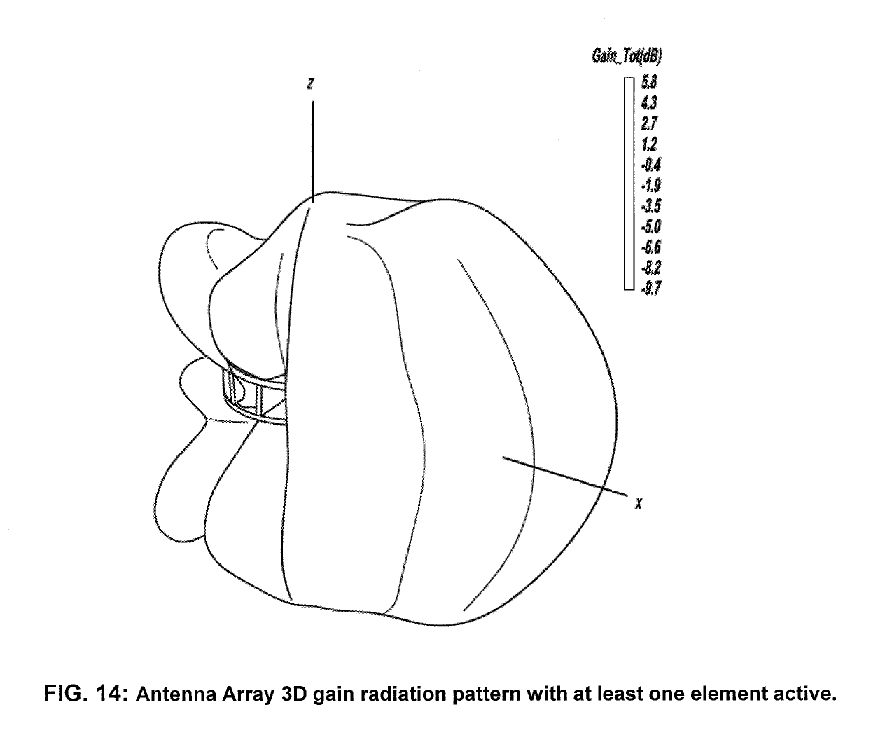

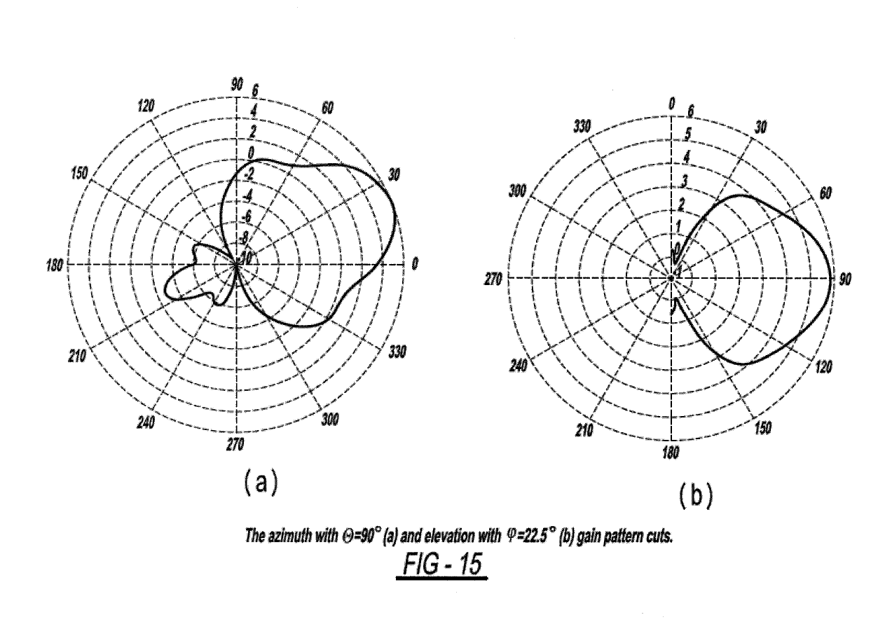

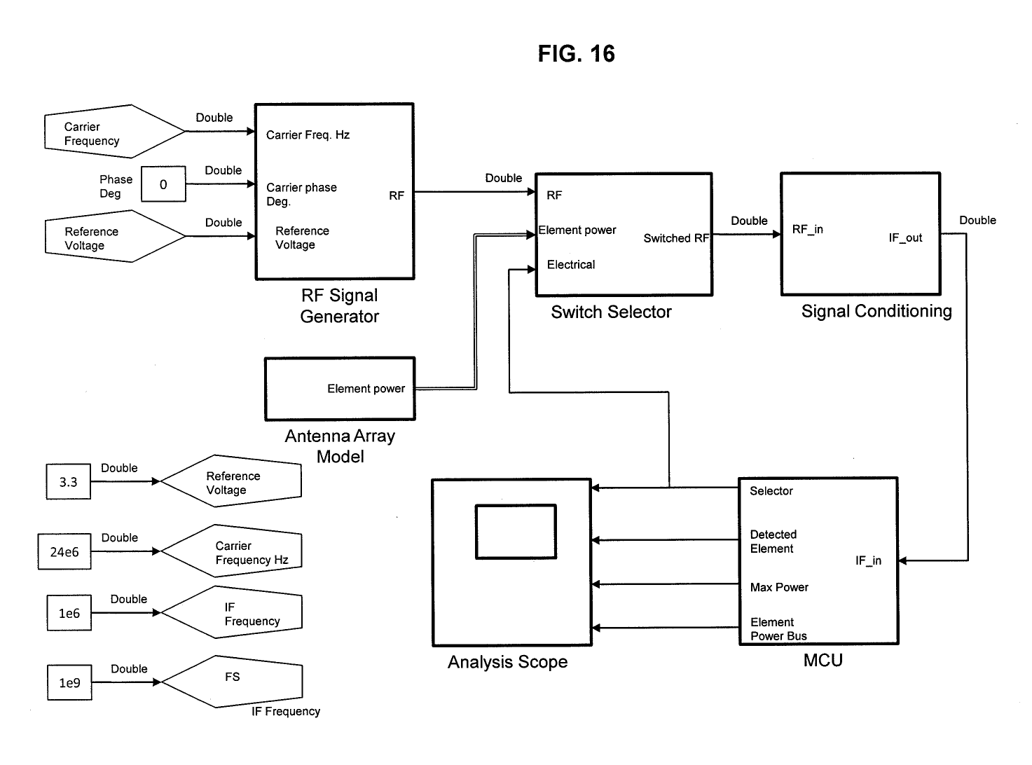

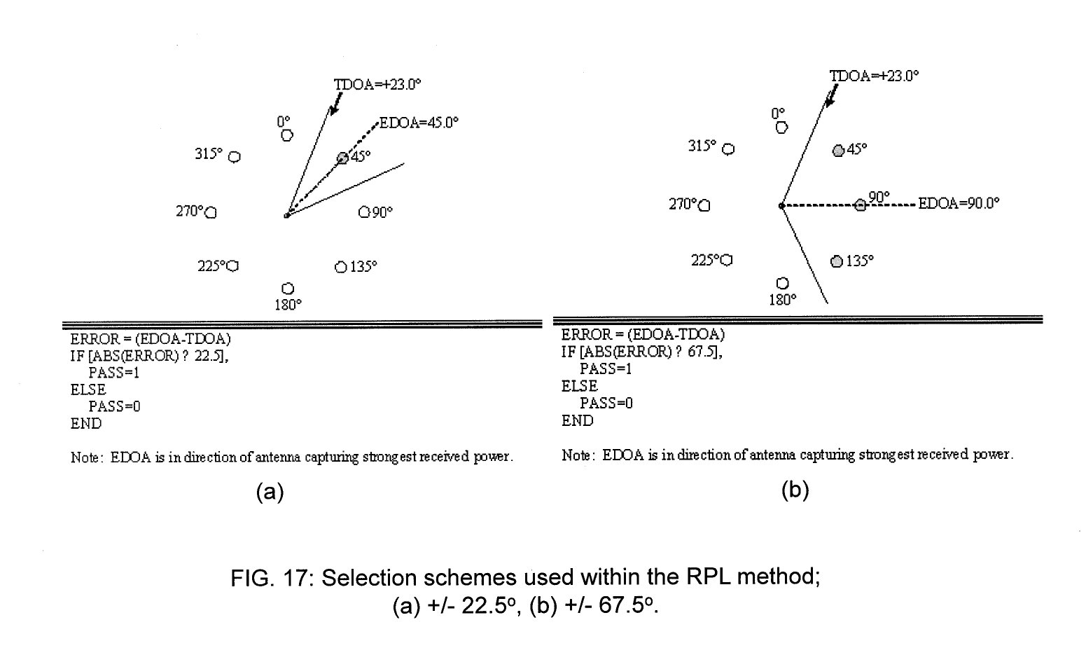

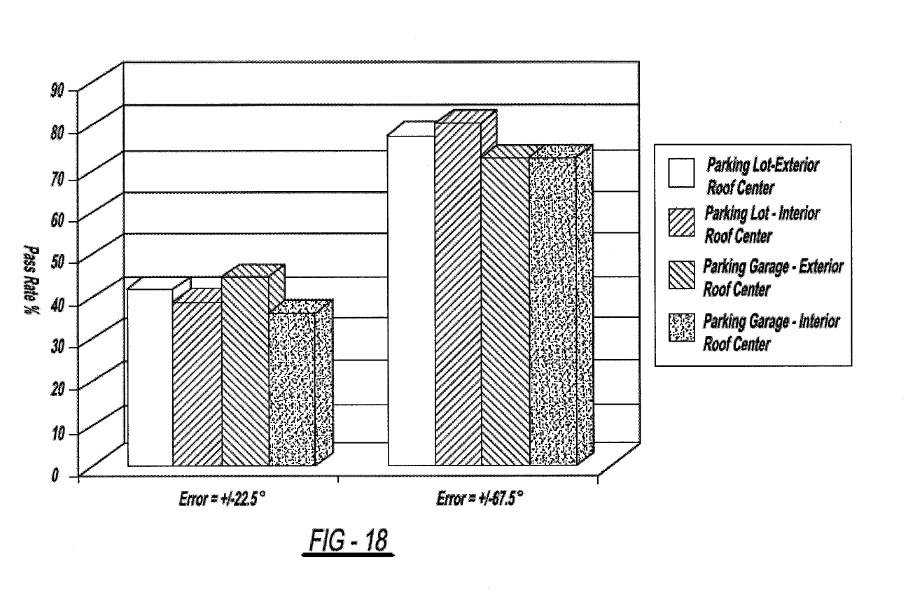

The RPL method, shown in a system level diagram of FIG. 12, was used in a car finder system operating at 2.4 GHz. The receiver module consists of the transmitting transmission device, such as a key fob, the receiving antenna array, and direction finding procedure and electronics.

System-Level Description—The car finder system will utilize the RPL method for locating the location of the user's vehicle in a complex environment (i.e., open field, open parking lot, and/or parking garage). FIG. 11 illustrates a computerized model of a vehicle 10, with the receiver array 113 location on top of the roof of the vehicle. In this example, the array 113 includes an 8-antenna element array. This model was created using a standard car structure within WIRELESS INSITE.

FIGS. 13A-13B illustrates the dimensions and structure of an exemplary metal housing 114 with the antenna array 113. In this example, the housing 114 defines a 10 cm radius in the embodiment shown. The height is 4 cm axially and individual antennas 116 align parallel to the axial direction. The array is not physically rotated. A rotating switch is used to switch between the various antenna 116 elements. In this example, metal side-walls 115 are disposed axially between each element 116.

An 8-element antenna array 113 was designed using FEKO and simulated to predict the radiation patterns and gain levels in different directions. The elements 1116 within the array are omni directional radiators with a center frequency of 2.4 GHz. The metal structure 114 that houses these 8-elements 116 will shape the radiation pattern, and produce a HPBW_{φ}=45° when a single element 116 is activated, thus covering that sector. FIG. 13A illustrates the 3D model of the antenna array 113.

The 3D gain pattern and the azimuth and elevation cuts when the antenna in sector 1 is active are shown in FIG. 14, and FIGS. 15(a)-15(b). Such a radiation pattern can be utilized to locate the direction of the incoming key fob wave. The sector with the highest power (more complicated algorithms can be utilized to increase the success probability of identifying the true direction of the incoming signal) will be chosen as the sector where the signal is coming from.

In an example, the signal processing part of the car finder system is presented in a flow chart of FIG. 16. The antenna array is connected to a rotating switch that completes a full revolution at a speed of 40 msec. Each sector (antenna) will have 5 msec of dwell time. The data from each antenna is passed to a single receiver module. The RF front-end will amplify and filter the incoming signal, down convert it to an acceptable IF, and then pass it to an ADC. The ADC will sample and digitize the data for a single antenna, and passes the digitized data to the MCU. The MCU will rely on its program to calculate the power level estimate for the 5 msec time interval for a specific antenna, and dumps the results in a specified memory location. This process is repeated 8 times, once for each antenna. Then the MCU compares the power levels and sorts them according to a selection algorithm. This will give the antenna location with highest probability of the incoming signal, and that sector is chosen. The receiver identifies this sector and processes the data to be sent back to the key fob. FIG. 16 shows the SIMULINK model of the complete signal processing chain for the car finder system.

SIMULINK modeling was chosen to be able to utilize the rapid prototyping approach. Once the model is finalized, the MCU code can be generated and downloaded on hardware. Several model parameters can be altered within the model to compensate for hardware delays, and this can be finalized when the prototype is built.

Two simple selection procedures were suggested; one that only considers +/−22.5° error window, and another that considers a +/−67.5° error window. The former will identify one sector out of 8, while the later will identify 3 sectors. This gives the user a crude estimate on the location of the car during the first search, then when pressing the transmission device (i.e., key fob) another time, the search space will be narrowed to one sector. This procedure will eliminate some false locations while in highly reflective environments. FIGS. 17(a)-17(b) show the two selection schemes used.

Results—The results from using the design model described in section (2) is shown in the bar chart in FIG. 18. The chart shows the pass rate results in two complex environments; the parking garage and the open parking lot. Two locations for the receiver were investigated, the exterior roof top center location and the interior roof center location. The pass rate is based on one of the two selection methods; +/−22.5° and +/−67.5°. In the former, the pass rate results were between 35-40% for the two locations inside both environments. The pass rates were doubled when the later selection methods was used. Although the +/−67.5° covers 3 sectors, and thus will not be precise to within 1 sector, it will guide the user to the correct direction, after which he/she might press the key fob another time to narrow the variation and get guidance to within +/−22.5°.

The architecture for the car finder shows embodiments with more than 70% pass rate with the second selection algorithm. The selection algorithm can be modified, and more complex selection methods can be investigated and implemented to improve the pass rate. The design is targeted for a low cost low complexity type of design.

Conclusions—The following conclusions were drawn: (i) A phased based methods will not be suitable for use as the basis of a car finder system in complex wireless environments; (ii) A RPL method is suitable for the construction and implementation of a car finder system. The RPL embodiment consisted of an 8-element antenna array, signal processing chain, and a selection algorithm; (iii) The 8-element embodiment was based on analysis, modeling, and simulation studies with complex wireless environments. The RPL system showed about 40% pass rate (correct detection) within an error +/−22.5°, and about 80% pass rate within an error of +/−67.5° in parking garage and open parking wireless environments; (iv) The RPL system is targeted for a low cost, low complexity compact design that can be produced in mass volumes in the future; and (v) The forward link components were designed and assessed.

The present disclosure has been described in an illustrative manner. It is to be understood that the terminology which has been used is intended to be in the nature of words of description rather than of limitation. Many modifications and variations of the present disclosure are possible in light of the above teachings. Therefore, within the scope of the appended claim, the present disclosure may be practiced other than as specifically described.

We claim:

1. A system for locating a vehicle which comprises:
(a) a transmission device for transmission and receiving of a signal which comprises a plurality of indicators arranged in a plurality of angular locations relative to a reference point, the transmission device is adapted to be held by a user and transmit a radio frequency or microwave frequency transmission signal;
(b) an antenna array positioned on or in a vehicle, the array comprising a plurality of antennas arranged in a plurality of angular locations relative to a reference point, the array is adapted to receive the transmission signal from the transmission device at each antenna;
(c) a microcontroller unit adapted to: (i) receive digital data converted from the transmission signal, (ii) calculate an angle of arrival (AOA) or direction of arrival (DOA) based on known components and an algorithm; and (iii) transmit a signal back to the transmission device to indicate the AOA or DOA on the indicators; and
(d) a signal processing unit comprising a switch to alternate between each antenna to obtain a signal transmission at each antenna one by one and provide signal conversion, wherein the signal processing unit is coupled to the plurality of antennas and the microcontroller unit, and wherein the signal processing unit is adapted to receive the signal transmission from each antenna one by one, convert the signals to digital data, and transmit the digital data to the microcontroller unit.

2. The system of claim 1 wherein the algorithm is selected from the group consisting of an analog single channel pseudo-doppler algorithm (A-SCPD), a digital phase lock loop algorithm (D-PLL), and a received power level algorithm (RPL).

3. The system of claim 1 wherein the algorithm is a received power level algorithm (RPL) adapted to calculate the power level at each antenna, select the antenna receiving the highest power, and transmit a signal to the transmission device to activate the indicator corresponding to the highest receiving power antenna which indicates the direction of the antenna array with respect to the transmission device.

4. The system of claim 3 wherein the antenna array comprises 8 directional antennas arranged in a circular configuration spaced apart 45° with respect to each other.

5. The system of claim 3 wherein the microcontroller unit is adapted to receive digital data converted from the transmission signal, calculate a power level for each antenna in the array, sort the antennas according to each antenna's power level, and cause the antenna selected with the highest probability of receiving the transmitted signal to transmit a signal back to the transmission device to cause one of the plurality of indicators to turn on, wherein the indicator that is turned on is associated with the direction of the vehicle with respect to the transmission device.

6. The system of claim 3 wherein the array of antennas is operable to calculate a substantially accurate DOA in an open field, a parking lot filled with other vehicles, and a parking garage filled with other vehicles and having walls and other structures.

7. The system of claim 3 wherein the antennas are adapted to operate at a half-power beam width (HPBW) of 45°, 90°, and 135°.

8. The system of claim 3 wherein the DOA estimates fall within a threshold value ranging from about 22.5° to 67.5°.

9. The system of claim 8 wherein the system achieves DOA estimates of at least 40% pass rate for a 22.5° threshold and at least 70% pass rate for 67.5° threshold in a parking garage or open parking environment.

10. The system of claim 3 wherein the antenna array is mounted in a metal housing comprising metallic side-walls positioned between the individual antennas and having a top and bottom surface positioned above and below the antennas respectively and the antennas align parallel to an axial axis through the center of the housing.

11. The system of claim 1 wherein the array of antennas comprises 4 to 8 antennas.

12. The system of claim 1 wherein the antennas are configured in a circular array defining a radius from about a quarter-wavelength to a half-wavelength.

13. The system of claim 1 wherein the transmission device is operable to transmit a signal at a wavelength ranging from about 915 MHz to 2.4 GHz.

14. The system of claim 1 wherein the antenna array is placed on an exterior roof of the vehicle substantially in the center of the roof top or on an interior of the vehicle substantially mounted to the center of the roof console.

15. The system of claim 1 wherein the transmission device is a key fob and the indicators are light emitting diode (LED) indicators, wherein the LED indicators are arranged in a circular pattern and correspond to the number of antennas mounted on the vehicle.

16. A method for finding a vehicle comprising the steps of:
(a) transmitting a radio frequency or microwave frequency signal from a transmission device to an antenna array positioned on or in a vehicle, wherein the array comprises a plurality of antennas arranged in a plurality of angular locations relative to a reference point adapted to receive a transmission signal from the transmission device, and wherein the transmission device comprises a plurality of indicators arranged in a plurality of angular locations relative to a reference point and is adapted to be held by a user;
(b) processing the transmission received by the antenna array through a signal processing unit comprising a switch to alternate between each antenna to obtain a signal transmission at each antenna one by one, wherein the signal processing unit is coupled to the plurality of antennas and a microcontroller unit, wherein the signal processing unit is adapted to receive the signal transmission from each antenna one by one, convert the signals to digital data, and transmit the digital data to the microcontroller unit;
(c) calculate an angle of arrival (AOA) or direction of arrival (DOA) with the microcontroller unit based on predetermined values and an algorithm using the digital data from the signal processing unit; and
(d) transmitting a signal based on the AOA or DOA to the transmission device to activate at least one of the indicators to direct the user towards the vehicle.

17. The method of claim 16 wherein the algorithm is a received power level algorithm (RPL) that calculates the power level at each antenna, selects the antenna receiving the highest power, and transmits a signal to the transmission device to activate the indicator corresponding to the highest receiving power antenna which indicates the direction of the antenna array with respect to the transmission device.

18. A direction finder apparatus comprising:
(a) an antenna array adapted to be mounted on or in an object, the array comprising a plurality of antennas arranged in a plurality of angular locations relative to a reference point adapted to receive a radio frequency or microwave frequency transmission signal from a transmission device;
(b) a metal housing comprising (i) metallic side-walls positioned between the individual antennas, and (ii) a top and bottom surface positioned above and below the antennas respectively,
wherein the antennas are aligned parallel to an axial axis through the center of the housing, and
wherein the antenna array is coupled to a signal processing unit comprising a switch to alternate between each antenna to obtain a signal transmission at each antenna one by one and provides signal conversion, and coupled to a microcontroller unit for processing the transmission signal and transmitting a signal back to the transmission device to indicate the direction of the object.

19. The apparatus of claim 18 wherein the object is a vehicle.

20. The apparatus of claim 18 wherein the object is adapted to be carried or removably mounted on a person.

21. A system for locating an object or location which comprises:
(a) a transmission device for transmission and receiving of a signal which comprises a plurality of indicators arranged in a plurality of angular locations relative to a reference point, the transmission device is adapted to be held by a user and transmit a radio frequency or microwave frequency transmission signal;
(b) an antenna array positioned on an object or at a location, the array comprising a plurality of antennas arranged in a plurality of angular locations relative to a reference point, the array is adapted to receive the transmission signal from the transmission device at each antenna;
(c) a microcontroller unit adapted to: (i) receive digital data converted from the transmission signal, (ii) calculate an angle of arrival (AOA) or direction of arrival (DOA) based on known components and an algorithm; and (iii) transmit a signal back to the transmission device to indicate the AOA or DOA on the indicators; and
(d) a signal processing unit comprising a rotating switch to alternate between each antenna to obtain a signal transmission at each antenna one by one, wherein the signal processing unit is coupled to the plurality of antennas and the microcontroller unit, and wherein the signal processing unit is adapted to receive the signal transmission from each antenna one by one, convert the signals to digital data, and transmit the digital data to the microcontroller unit.

22. The system of claim 19 wherein the algorithm is a received power level algorithm (RPL) adapted to calculate the power level at each antenna, select the antenna receiving the highest power, and transmit a signal to the transmission device to activate the indicator corresponding to the highest receiving power antenna which indicates the direction of the antenna array with respect to the transmission device.
